(19) United States
(12) Patent Application Publication
(10) Pub. No.: US 2021/0360425 A1
(43) Pub. Date: Nov. 18, 2021

(54) DETECTING INDOOR/OUTDOOR STATUS OF MOBILE COMMUNICATION DEVICES

(71) Applicant: T-Mobile USA, Inc., Bellevue, WA (US)

(72) Inventors: Antoine T. Tran, Bellevue, WA (US); Emile Minh Tran, Sammamish, WA (US); Bryan Yang, Seattle, WA (US)

(73) Assignee: T-Mobile USA, Inc.

(21) Appl. No.: 16/872,729

(22) Filed: May 12, 2020

(51) Int. Cl. H04W 16/18; H04W 24/10; H04L 25/02; G01S 1/68; G01S 5/02; G01S 15/89; G01S 17/89; G01C 21/20

(52) U.S. Cl. CPC H04W 16/18; H04W 24/10; H04L 25/0212; G01C 21/206; G01S 5/0252; G01S 15/8906; G01S 17/89; G01S 1/68

(57) ABSTRACT

When deploying or upgrading an enhanced cellular communication system, a site survey may be performed by configuring cellular devices in a given area to report various operational metrics. The devices may also be configured to report environmental data that can be used to determine whether the devices are indoors or outdoors, which may be useful when interpreting the operational metrics. The environmental signatures may include an audio signature, which may comprise an audio impulse response produced by an acoustic echo canceller (AEC) of the device. The environmental signatures may further include a light signature, which may be based on frequency components of ambient light. The environmental signatures may further include an audio signature, which may be based on characteristics of radio signals received by the device. Machine learning techniques may be used, with the environmental signatures as features, to predict whether a given device is indoors or outdoors.

### BACKGROUND

When deploying an enhanced cellular system for a particular area or facility, a site survey may be performed to gain an understanding of customer usage and signal propagation at various places in the area or facility. This information may be used to determine requirements of the enhanced cellular system, such as required gain, bandwidth, and power. The information may also be used to determine optimal placement of base stations and repeaters.

A site survey may also be performed to identify improvements that may be made to an existing cellular network to increase the quality of network coverage in an area or facility. For instance, a site survey may indicate locations within a building where cellular signals are weak or unusable so that changes to an existing system can be made to improve the signals.

Site surveys can be even more important when deploying newer generations of cellular networks such as 5th-Generation (5G) networks, particularly in cases where the networks use relatively high frequencies that do not propagate well through physical objects and barriers such as walls, floors, ceilings, and windows of buildings.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different figures indicates similar or identical components or features.

FIG. 1 is a block diagram of a cellular communications environment within which in which the techniques described herein may be implemented.

FIG. 2 is a flow diagram illustrating an example method of providing operational metrics and environmental signatures.

FIG. 3 is a flow diagram illustrating an example method of creating a classification model for use in determining whether reporting cellular devices are indoors or outdoors.

FIG. 4 is a flow diagram illustrating an example method that uses environmental signatures to determine whether reporting cellular devices are indoors or outdoors.

FIG. 5 is a block diagram of an example computing device that may be used to implement various functionality described herein.

### DETAILED DESCRIPTION

Described herein are techniques for determining whether cellular communication devices are indoors or outdoors, particularly in situations in which the cellular devices are being used to report operational metrics such as signal characteristics and performance data. Devices may be used in this way, for example, when conducting a site survey to optimize a new deployment of a cellular network or to identify locations at which existing cellular network coverage is inadequate. When conducting a site survey, for example, existing cellular base stations may gather operational metrics from multiple cellular communication devices served by the base stations. Operational metrics may include GPS coordinates, signal strengths, signal round-trip times, access point names, cellular tower identifications, data communication speeds, data consumption, and other data that may be relevant to determining deployment requirements for a particular area.

When receiving and interpreting data such as this from reporting devices, it is important to know whether the reporting devices are indoors or outdoors. This knowledge may impact the way the operational metrics are interpreted as well as the actions that are taken in in light of the operational metrics.

In accordance with embodiments described herein, various sensors of a cellular communication device are used to determine whether the device is indoors or outdoors. In particular, sensor data is used to create environmental signatures that vary depending on the environment of the device. The environmental signatures are then analyzed to predict whether the device is indoors or outdoors.

Environmental signatures may relate to audio, light, and radio characteristics of the ambient space in which a device is located and being used. In some environments, signatures that are manually labeled as either indoor or outdoor signatures may be accumulated and used as training data for a machine-learning binary classifier. The resulting trained classifier may then be used to analyze unlabeled signatures from devices and to predict whether those devices are indoors or outdoors.

An audio signature is an example of an environmental signature that may be used to determine whether a device is indoors or outdoors. In a described embodiment, an audio signature comprises an audio impulse response obtained from a built-in audio echo canceller (AEC) of an audio communication device. During two-way audio communications, an AEC is used to remove loudspeaker audio from the microphone signal of a device. The AEC may be implemented using a digital adaptive finite impulse response (FIR) filter that is dependent on the audio impulse response of the device's environment. Rather than measuring the impulse response directly, however, an AEC has a learning algorithm that learns the impulse response based on the loudspeaker signal, the microphone input signal, and the filtered microphone signal. The learning algorithm operates continuously to update the impulse response in response to changes in the environment.

When using a digital adaptive FIR as part of an AEC, the audio impulse response is represented by a sequence of coefficients, which may also be referred to as filter weights. In a described embodiment, such a sequence of coefficients may be used as an audio signature to represent the acoustic impulse response of the space within which the device is located (i.e., the room impulse response).

An audio signature such as this may be useful in determining whether the device is indoors or outdoors because indoor spaces typically exhibit different impulse responses than outdoor spaces.

A light signature is another example of an environmental signature that may be used to determine whether a device is indoors or outdoors. In a described embodiment, a light signature is generated based on observed frequencies of ambient light, including the frequencies of light intensity and color temperature signals. For example, a camera or other sensor of the device may be monitored to obtain a light intensity signal over a short time period. The light intensity signal may then be analyzed to determine its frequency or frequencies. In some embodiments, the light intensity signal may be analyzed to generate a Fourier transform that represents frequency components of the ambient light, and the Fourier transform may be used as a light signature that represents ambient light frequencies. In other embodiments, a digital representation of the light intensity signal itself may be used as a light signature.

A light signature may be useful in determining whether a device is indoors or outdoors because indoor spaces often have artificial light with frequency components that are absent from natural outdoor light. For example, some types of artificial lights may have a frequency component of 50 Hertz (Hz) or 60 Hz, reflecting the frequency of mains power supplied to the lights. Natural light, on the other hand, is relatively constant and does not exhibit the same frequency characteristics.

Frequency components of a color temperature signal, obtained using a device sensor, may be monitored and analyzed in a similar way as an indication of whether the device is in an indoor environment or an outdoor environment.

A radio signature is another example of an environmental signature that may be used to determine whether a device is indoors or outdoors. In a described embodiment, a radio signature is based on measurements of various radio signals received by the device at a particular location. These signals may include Bluetooth signals, Wi-Fi signals, cellular signals, GPS signals, near-field signals, etc. In some cases, a radio signature may be based on metadata, such as network and/or device names, that is conveyed by or associated with a radio signal. In some cases, a radio signature may be based on radio signal characteristics such as signal strength, frequency, and round-trip times (RTTs). These types of signal information may be represented and combined in a predetermined way to create a radio signature.

A radio signature such as this may be useful in determining whether the device is indoors or outdoors because radio signal characteristics often vary depending on the location of the device. For example, the presence of a Wi-Fi signal typically corresponds to a relatively high likelihood that the device is indoors. As another example, a relatively high ratio of cellular signal strength to Wi-Fi signal strength may indicate a likelihood that the device is outdoors. As yet another example, a relatively strong global positioning satellite (GPS) signal may be interpreted as an indicator of likelihood that the device is outdoors.

Environmental signatures reported by cellular devices are analyzed by server components to determine whether the reporting devices are indoors or outdoors. In some embodiments, machine learning techniques may be used to determine whether reporting devices are indoors or outdoors based on environmental signatures such as described herein.

In some cases, the cellular devices themselves may calculate signatures based on sensor data and report the signatures to the server components. In other cases, devices may report sensor to server components, and the server components may calculate the signatures.

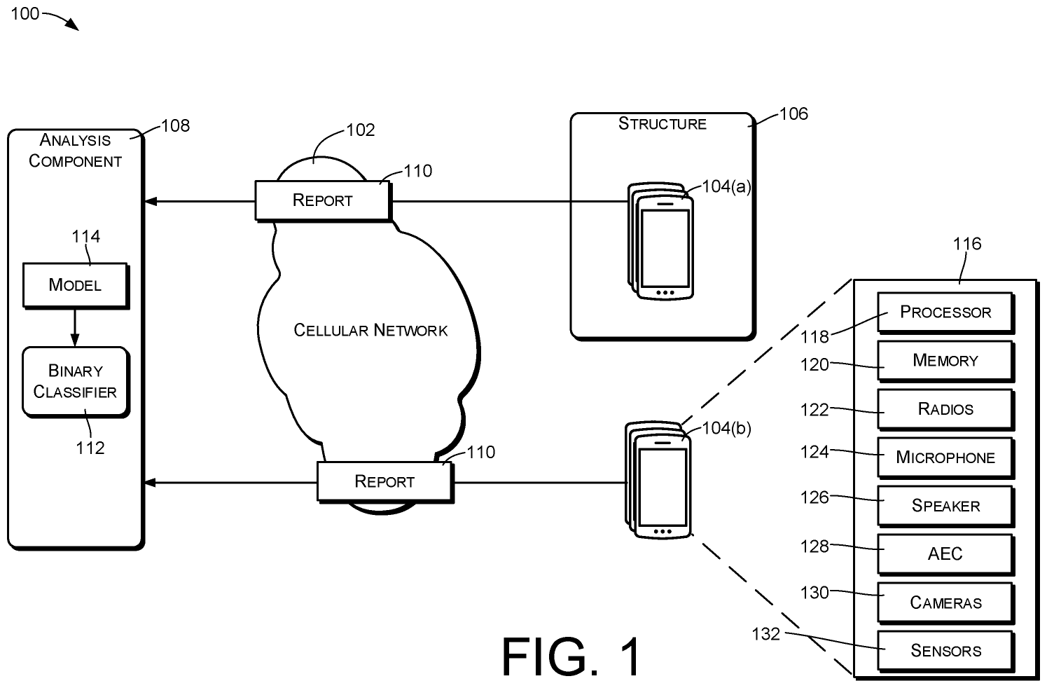

FIG. 1 illustrates an example environment 100 in which the described techniques may be implemented. FIG. 1 shows a cellular network 102 that supports multiple cellular communication devices 104, which include indoor devices 104(a) that are within a structure 106 and outdoor devices 104(b) that are not within a building or structure.

The devices 104 may comprise any of various types of mobile communication devices that are capable of wireless data and/or voice communications, including smartphones and other mobile devices, “Internet-of-Things” (IoT) devices, smart home devices, computers, wearable devices, entertainment devices, industrial control equipment, etc. In certain environments, a device 104 may be referred to as a user equipment (UE) or mobile station (MS).

The cellular network 102 may comprise any type of wireless communication network, including various generations of cellular systems such as 3rd-Generation (3G), 4th-Generation (4G), and 5th-Generation (5G) cellular systems. The devices 104 may communicate through the network infrastructure of the cellular network 102 to support audio, video, and data communications with various entities, including servers and services that are accessible through the Internet.

In the described embodiment, the cellular communication devices 104 are configured to communicate through the cellular network 102 with an analysis component 108 and to send reports 110 to the analysis component. A report 110 provided by a reporting communication device 104 may specify operational metrics relating to that device. In addition, a report 110 may specify environmental signatures that can be analyzed by the analysis component 108 to determine whether the reporting communication device is indoors or outdoors. Environmental signatures may include audio signatures, light signatures, radio signatures, and possibly other types of data. Environmental signatures such as this will be described in more detail below.

Although the reports 110 are described herein as being provided over the cellular network 102, the reports 110 may alternatively be provided over any type of network. As another alternative, the reports 110 may be stored by the devices 104 and retrieved using means other than network communications.

The analysis component 108 may comprise a computer, server, service, or other computing entity that is configured to analyze reported operational metrics. The analysis component 108 may be configured, for example, to determine usage and signal characteristics at various locations within an area of interest. In addition, the analysis component 108 may be configured to analyze reported data to determine whether any given communication device 104 is indoors or outdoors. Interpretations and analysis of operational metrics gathered from a particular communication device may vary depending on whether the device is indoors or outdoors.

In a described embodiment, the analysis component 108 uses a binary classifier 112, based on a trained model 114, to determine, based on environmental signatures contained in the reports 110, whether any particular reporting device 104 is indoors or outdoors. The model is 114 is created with machine learning techniques, using environmental signatures that have been labeled using other means to indicate whether they are associated with indoor or outdoor locations.

FIG. 1 illustrates relevant components 116 of an example communication device 104 such as might be used in the described environment. FIG. 1 shows only basic, high-level components of a device 104. Any of the indoor devices 104(a) or outdoor devices 104(b) may have components such as the components 116.

The device components 116 may include a processor 118 and associated memory 120. The memory 120 may include both volatile memory and non-volatile memory. The memory 120 can also be described as non-transitory computer-readable media or machine-readable storage memory, and may include removable and non-removable media implemented in any method or technology for storage of information such as computer executable instructions, data structures, program modules, or other data. Additionally, in some embodiments the memory 120 may include a SIM (subscriber identity module), which is a removable smart card used to identify a user of the device 104 to a service provider network.

The memory 120 may include, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other tangible, physical medium which can be used to store the desired information. The memory 120 may in some cases include storage media used to transfer or distribute instructions, applications, and/or data. In some cases, the memory 120 may include data storage that is accessed remotely, such as network-attached storage that the device 104 accesses over some type of data communications network.

The memory 120 stores one or more sets of computer-executable instructions (e.g., software) such as programs that embody operating logic for implementing and/or performing desired functionality of the device 104. The instructions may also reside at least partially within the processor 118 during execution thereof by the device 104. Generally, the instructions stored in the computer-readable storage media may include an operating system and various applications that are executed by the processor 118. The memory may also store data that is associated with and/or used by the operating system and applications.

In some embodiments, the processor(s) 118 is a central processing unit (CPU), a graphics processing unit (GPU), both CPU and GPU, or other processing unit or component known in the art. Furthermore, the processor(s) 118 may include any number of processors and/or processing cores. The processor(s) 118 is configured to retrieve and execute instructions from the memory 120.

The device 104 may have various types of wireless interfaces, enabled by one or more radios 122. The radios 122 may support wireless interfaces such as an Ethernet interface, a wireless local-area network (WLAN) interface, a near-field interface, a Bluetooth® interface, and so forth. The radios 122 may also include radios used for wireless cellular communications, sch as a Long-Term Evolution (LTE) radio, a 5^{th}-Generation (5G) radio (also referred to as a New Radio (NR) radio), and so forth. The radios 122 may also include a radio used for reception of Global Positioning System (GPS) signals, which may be used to determine geographic locations. The radios 122 transmit and/or receive radio frequency communications via an antenna (not shown).

The device 104 may have one or more microphones 124 or other audio sensors. For example, the device 104 may include one or more microphones used for voice communications. The device 104 may also have one or more speakers or other audio output devices 126, which may be used for voice communications and other types of audio.

In the described embodiment, the device 104 has an acoustic echo canceller (AEC) 128, which is used by the device 104 to remove audio produced by the speaker(s) 126 from a microphone signal produced by the microphone(s) 124. The AEC 128 may be implemented using a digital adaptive finite impulse response (FIR) filter that is dependent on the impulse response of the device's environment to cancel the loudspeaker audio from the microphone signal. The AEC 128 may have a learning algorithm that learns the impulse response based on the loudspeaker signal, the microphone input signal, and the filtered microphone signal. The learning algorithm operates continuously to update the impulse response in response to changes in the environment. The impulse response may be represented as a sequence of coefficients or weights that are used by the FIR filter of the AEC 128.

The device 104 may have one or more cameras 130 or other optical sensors, which may be used as light sensors to determine intensity and/or color temperature of ambient light. For example, many smartphones have both front-facing and rear-facing cameras for capturing photographic images, and which may also be used as light sensors. The device 104 may also have other optical sensors, such as an ambient light sensor used for display dimming

The device 104 may have other sensors 132 such as a barometer, an accelerometer, a gyroscope, a magnetometer, a thermometer, a global positioning system (GPS) device, a proximity sensor, and possibly other types of sensors. The sensors 132 allow the device 104 to determine location, motion, orientation, barometric pressure, temperature, and so forth,

Among other components not shown, the device 104 may have a display such as a liquid crystal display. In the case of a smartphone, the display may be a touch-sensitive display screen, which may also act as an input device or keypad, such as for providing a soft-key keyboard, navigation buttons, or the like. In other cases, the device 104 may include other types of user input/output devices, such as buttons, keys, fingerprint sensors, annunciators, indicator lights, a vibrating mechanism, a tactile feedback mechanism, and so forth. The device 104 may also have ports for one or more peripheral devices, such as headphones, peripheral speakers, or a peripheral display.

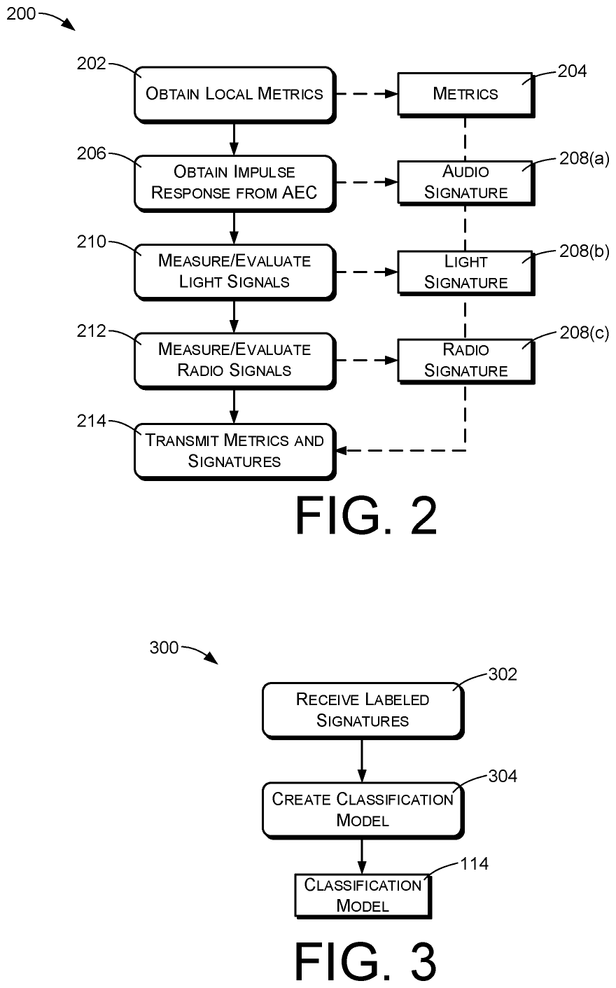

FIGS. 2-4 illustrate methods that may be performed to classify communication devices as being indoors or outdoors based on data received from the devices. For example, the described methods may be performed in conjunction with a site survey conducted for a particular geographic area or facility prior to deployment of new or enhanced cellular communication services. The described methods may also be performed in order to evaluate existing cellular communication services in an area or facility.

FIG. 2 illustrates an example method 200 that may be implemented by a cellular communication device or other mobile communication device as part of a technique for classifying the communication device as being indoors or outdoors. For example, the method 200 may be implemented by any of the devices 104 of FIG. 1. In some cases, a special-purpose application may be installed on the devices 104 to perform the method 200. In other cases, some or all of the functionality represented by the method 200 may be implemented as part of an operating system and/or firmware of the devices 104.

An action 202 comprises receiving local operational metrics 204 that may be used by the analysis component 108 as part of a site survey. These metrics relate to wireless communications of the device and may include information such as cellular signal strengths, data speeds, data consumption, device type, location, user identification, device identification, GPS coordinates, signal round-trip times, access point names, cellular tower identifications, and so forth.

An action 206 comprises obtaining an audio signature 208(a), which in the described embodiment comprises the acoustic impulse response of the room or other space in which the device is located. In the described embodiment, the action 206 may comprise obtaining an audio impulse response from the AEC of the device, such as the AEC 128 shown in FIG. 1. The room impulse response may be represented as a sequence of coefficients, weights, or other values, such as values learned and used by a digital adaptive FIR of the AEC 128.

An action 210 comprises measuring and/or evaluating one or more light signals to create a light signature 208(b). As an example, the action 210 may comprise analyzing a light intensity signal or a light color temperature signal to detect frequencies of the light intensity signal or the light color temperature signal. More specifically, the action 210 may comprise calculating a Fourier transform of a light signal as a representation of the frequencies exhibited by the light signal, and using the Fourier transform as the light signature 208(b). In other cases, a representation of the light signal itself may be used as the light signature 208(b).

Light signals may be produced by optical sensors of the device, such as front-facing cameras, rear-facing cameras, proximity sensors, ambient light sensors, and so forth.

An action 212 comprises measuring and/or evaluating one or more radio signals to produce a radio signature 208(c). For example, the action 212 may comprise measuring signal strengths of various types of radio signal received by radios of the device, including cellular signals, Bluetooth signals, Wi-Fi signals, GPS signals, and so forth. In some cases, the radio signature 208(c) may comprise a combination of these different signal strengths and other characteristics. In some cases, the radio signature 208(c) may be based on relative signal strengths of different types of signals received by the device, such as a ratio of measured Wi-Fi signal strength to measured cellular signal strength. The radio signature 208(c) may also, or alternatively, comprise data or metadata transmitted by one or more wireless network access points, such as names of wireless network access points from which radio communication signals are being received. In some cases, the action 212 may comprise estimating proximity of one or more components such as wireless network access points, based at least in part on one or more respective RF signals received from the one or more components by the subject communication device. For example, signal strengths, response times, and round-trip times may be analyzed to determine distances from wireless network access points.

An action 214 comprises transmitting the metrics 204, the audio signature 208(a), the light signature 208(b), and the radio signature 208(c) to an analytic entity such as the analysis component 108 of FIG. 1. The various metrics 204 and signatures 208 may be transmitted as one or more data objects through the cellular network 102 or through any other data network or communication media. In some cases, as will be described below, the signatures may be labeled as representing either indoor or outdoor locations and used to train a binary classifier. In other cases, the signatures are unlabeled, and the trained classifier may be used to classify devices as being indoors or outdoors based on their unlabeled environmental signatures.

FIG. 3 illustrates a method 300 that may be performed by the analysis component 108 based on labeled environmental signatures to create the trained classification model 114. The method 300 comprises an action 302 of receiving environmental signatures that have been labeled as either originating from a device that is indoors or originating from a device that is outdoors. More specifically, the labeled environmental signatures may comprise first labeled environmental signatures corresponding to indoor locations and second labeled environmental signatures corresponding to outdoor locations.

The labeled environmental signatures may include audio signatures 208(a), light signatures 208(b), and radio signatures 208(c) as described above with reference to FIG. 2. Each environmental signature is associated with a label indicating whether the device that generated the signature was indoors or outdoors at the time the signature, or the data on which the signature is based, was generated. Alternatively, a label such as this may be associated with a set of signatures received from an individual device.

The method 300 further comprises an action 304 of creating the trained classification model 114 with machine learning techniques, using the labeled environmental signatures as training data. As an example, a neural network algorithm may be used to create a binary classification model, using the labeled environmental signatures as features, to classify subject communication devices as being either indoors or outdoors based on unlabeled environmental signatures received from subject communication devices whose indoor/outdoor status is otherwise unknown.

Environmental signatures may be labeled using various techniques. In described embodiments, reference devices may be placed in locations that are known to be indoors or outdoors in order to generate corresponding labeled signatures. This may be done for various types of locations and indoor/outdoor environments. After gathering a comprehensive set of labeled signatures in this manner, representing different types of locations, the classification model can be created and used for analyzing environmental signals received from multiple subject devices whose indoor/outdoor status is unknown, without the need for further, site-specific training data.

Note that in addition to the environmental signatures described above, the classification model 114 may be based on any other available and potentially relevant features, including data and metrics obtained from any of multiple sensors of a cellular device. Examples of additional features that may be used by the classification model 114 include temperature, GPS coordinates, light intensity, ambient audio intensity or frequency, proximity measurements, time of day, etc.

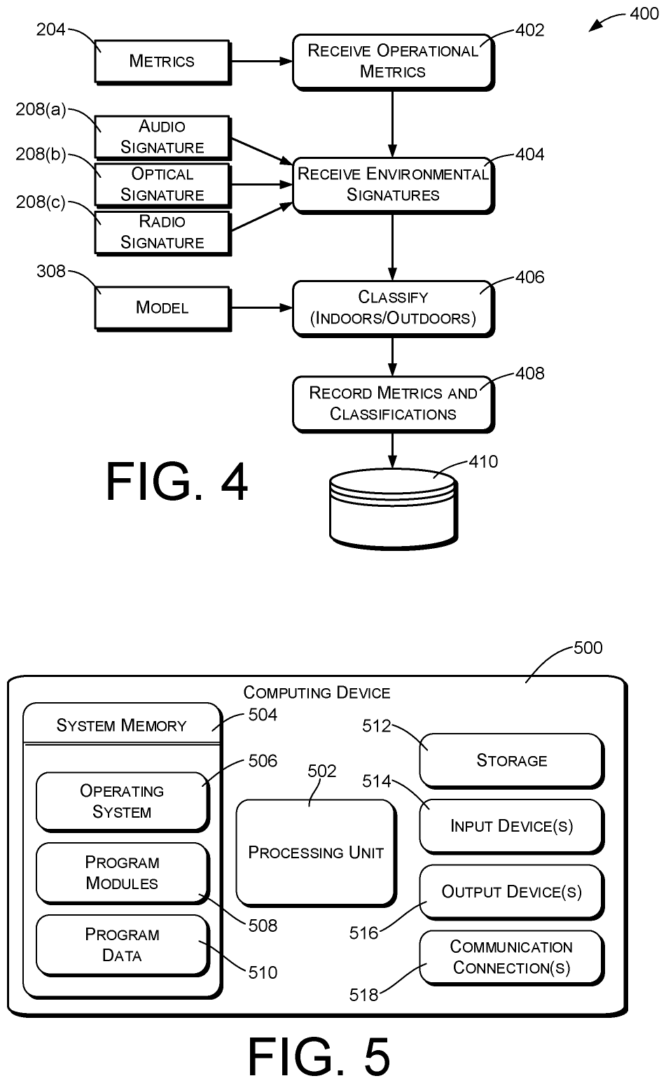

FIG. 4 illustrates a method 400 that may be used to determine whether a subject cellular communication device is in an indoor location or an outdoor location. The method 400 may be performed by the analysis component 108, for example, or by any other computational entity. The method 400 may be performed, for example, as part of a site study when deploying a new cellular communication system, or when enhancing an existing cellular communication system. The method 400 may also be used for evaluating performance of an existing cellular communication network in any geographic area or facility.

An action 402 comprises receiving operational metrics from a cellular communication device, such as the metrics 204 described above with reference to FIG. 2. The operational metrics may include any metrics that can be provided by the cellular device and that may be relevant to network performance and deployment.

An action 404 comprises receiving unlabeled environmental signatures from the cellular communication device, wherein the unlabeled environmental signatures include one or more of an audio signature 208(a), a light signature 208(b), and a radio signature 208(c) as described above. The metrics 204 and the environmental signatures 208 may be provided as one or more data objects. Also note that in some embodiments, the analysis component 108 may calculate or create the signatures 208 based on other data provided by a reporting device. For example, a cellular communication device may provide a waveform representing a light intensity signal and the analysis component 108 may calculate a Fourier transform, based on the waveform, indicating frequency components of the light signal.

An action 406 comprises classifying a particular reporting device as being either indoors or outdoors based on the unlabeled environmental signatures 208 received from the reporting device. In the embodiment described herein, the action 406 is performed by the binary classifier 112 using the trained classification model 114.

An action 408 comprises recording the received operational metrics 204 in a data store 410. The action 408 includes storing, with each set of operational metrics, a value or label indicating the classification (i.e., indoors or outdoors) of the device that provided the metrics.

FIG. 5 is a block diagram of an illustrative computing device 500 such as may be used to implement various of the techniques described above. Generally, one or more computing devices 500 may be used to implement any of the components and/or functionality of the analysis component 108 of FIG. 1.

In various embodiments, the computing device 500 may include at least one processing unit 502 and system memory 504. Depending on the exact configuration and type of computing device, the system memory 504 may be volatile (such as RAM), non-volatile (such as ROM, flash memory, etc.) or some combination of the two. The system memory 504 may include an operating system 506, one or more program modules 508, and may include program data 510.

The computing device 500 may also include additional data storage devices (removable and/or non-removable) such as, for example, magnetic disks, optical disks, or tape. Such additional storage devices are illustrated in FIG. 5 as storage 512.

Non-transitory computer storage media of the computing device 500 may include volatile and nonvolatile, removable and non-removable media, implemented in any method or technology for storage of information, such as computer readable instructions, data structures, program modules, or other data. The system memory 504 and storage 512 are all examples of computer-readable storage media. Non-transitory computer-readable storage media includes, but is not limited to, RAM, ROM, EEPROM, flash memory or other memory technology, CD-ROM, digital versatile discs (DVD) or other optical storage, magnetic cassettes, magnetic tape, magnetic disk storage or other magnetic storage devices, or any other medium which can be used to store the desired information and which can be accessed by computing device 500. Any such non-transitory computer-readable storage media may be part of the computing device 500.

In various embodiments, any or all of the system memory 504 and storage 512 may store programming instructions which, when executed, implement some or all of the functionality described above as being performed by the analysis component 108, such as creating the binary classifier 112 and using the binary classifier 112 for classifying devices as being indoors or outdoors. The system memory 504 and/or storage 512 may also be used for storage of the classification model 114.

The computing device 500 may also have input device(s) 514 such as a keyboard, a mouse, a touch-sensitive display, voice input device, etc. Output device(s) 516 such as a display, speakers, a printer, etc. may also be included. The computing device 500 may also contain communication connections 518 that allow the device to communicate with other computing devices.

Although features and/or methodological acts are described above, it is to be understood that the appended claims are not necessarily limited to those features or acts. Rather, the features and acts described above are disclosed as example forms of implementing the claims.

1. A method for classifying a subject communication device as being indoors or outdoors, the method comprising:
receiving first labeled environmental signatures, wherein the first labeled environmental signatures correspond to indoor locations;
receiving second labeled environmental signatures, wherein the second labeled environmental signatures correspond to outdoor locations;
using the first and second labeled environmental signatures as training data to train a binary classifier to classify subject communication devices as being either indoors or outdoors;
receiving at least one unlabeled environmental signature from the subject communication device; and
analyzing the at least one unlabeled environmental signature using the binary classifier to classify the subject communication device as being indoors or outdoors;
wherein an unlabeled environmental signature received from the subject communication device comprises at least:
an audio signature obtained by receiving an acoustic impulse response from an acoustic echo canceller of the subject communication device.

2. The method of claim 1, wherein obtaining the acoustic impulse response comprises obtaining coefficients of a finite impulse response (FIR) filter of the acoustic echo canceller.

3. The method of claim 1, wherein the at least one unlabeled environmental signature further comprises a light signature that represents a frequency of a light signal obtained from an optical sensor of the subject communication device, and
the method further comprising producing the light signature by calculating a Fourier transform of the light signal.

4. The method of claim 1, wherein
the at least one unlabeled environmental signature further comprises a light signature that represents a frequency of a light signal obtained from an optical sensor of the subject communication device; and
the light signature is based on one or more of light intensity and light color temperature.

5. The method of claim 1, wherein;
the at least one unlabeled environmental signature further comprises a radio signature obtained that represents one or more characteristics of one or more radio communication signals received by the subject communication device; and
the method further comprising producing the radio signature by measuring one or more signal strengths of the one or more radio communication signals, wherein the one or more radio communication signals comprise one or more of a Wi-Fi signal and a Bluetooth signal.

6. The method of claim 1, wherein:
the at least one unlabeled environmental signature further comprises a radio signature obtained that represents one or more characteristics of one or more radio communication signals received by the subject communication device; and
the method further comprising producing the radio signature based at least in part on identifying one or more wireless network access points from which the one or more radio communication signals are received.

7. The method of claim 1, wherein:
the at least one unlabeled environmental signature further comprises a radio signature obtained that represents one or more characteristics of one or more radio communication signals received by the subject communication device; and
the method further comprising producing the radio signature by estimating proximity of one or more components based at least in part on one or more respective RF signals received from the one or more components by the subject communication device.

8. The method of claim 1, wherein:
the at least one unlabeled environmental signature further comprises a radio signature obtained that represents one or more characteristics of one or more radio communication signals received by the subject communication device; and
the method further comprising producing the radio signature based at least in part on relative signal strengths of two or more radio communication signals received by the subject communication device.

9. A method for classifying a subject communication device as being indoors or outdoors, the method comprising:
receiving one or more environmental signatures from the subject communication device; and
analyzing the one or more environmental signatures to classify the subject communication device as being indoors or outdoors;
wherein the one or more environmental signatures comprise at least:
an audio signature produced by obtaining an impulse response from an acoustic echo canceller of the subject communication device.

10. The method of claim 9, wherein the one or more environmental signatures further comprise a radio signature, the method further comprising obtaining the radio signature by determining characteristics of one or more radio communication signals received by the subject communication device.

11. The method of claim 9, wherein the one or more environmental signatures comprise a radio signature, the radio signature comprising data transmitted by one or more wireless network access points.

12. The method of claim 9, wherein:
the one or more environmental signatures further comprise a light signature that represents a frequency of a light signal obtained from an optical sensor of the subject communication device; and
the method further comprising obtaining the light signature by determining a frequency of a light intensity signal or a color temperature signal.

13. The method of claim 9, wherein:
the one or more environmental signatures further comprise a light signature that represents a frequency of a light signal obtained from an optical sensor of the subject communication device; and
the method further comprising obtaining the light signature by calculating a Fourier transform of a light intensity signal or a color temperature signal.

14. The method of claim 9, further comprising obtaining the audio signature by obtaining an acoustic impulse response from an acoustic echo canceller of the subject communication device.

15. The method of claim 9, further comprising obtaining the audio signature by obtaining coefficients used by a finite impulse response (FIR) filter of an acoustic echo canceller of the subject communication device.

16. A cellular communication device comprising:
a radio;
an optical sensor;
an audio sensor;
an acoustic echo canceller that determines an acoustic impulse response for acoustic echo cancellation;
one or more processors;
one or more non-transitory computer-readable media;
the one or more non-transitory computer-readable media storing computer-executable instructions that, when executed by the one or more processors, cause the one or more processors to perform actions comprising:
transmitting one or more operational metrics to an analysis component; and
transmitting environmental signatures to the analysis component to be used by the analysis component to determine whether the cellular communication device is indoors or outdoors, the environmental signatures comprising:
the acoustic impulse response used by the acoustic echo canceller.

17. The cellular communication device of claim 16, wherein the acoustic impulse response comprises coefficients of a finite impulse response (FIR) filter of the acoustic echo canceller.

18. The cellular communication device of claim 16, wherein:
the environmental signatures further comprise a light signature representing a frequency of a light signal obtained using the optical sensor; and
the light signature comprises a Fourier transform of the light signal.

19. The cellular communication device of claim 16, wherein:
the environmental signatures further comprise a radio signature representing one or more characteristics of one or more radio communication signals received using the radio; and
the radio signature comprises one or more signal strengths of the one or more radio communication signals.

20. The cellular communication device of claim 16, wherein:
the environmental signatures further comprise a radio signature representing one or more characteristics of one or more radio communication signals received using the radio; and
the radio signature comprises an identification of a wireless network access point from which the one or more radio communication signals are received.
